(19) United States
(12) Patent Application Publication
(10) Pub. No.: US 2026/0040271 A1
(43) Pub. Date: Feb. 5, 2026

(54) INFORMATION PROCESSING APPARATUS, INFORMATION PROCESSING METHOD, AND NON-TRANSITORY COMPUTER READABLE MEDIUM

(71) Applicant: Rakuten Group, Inc., Tokyo (JP)

(72) Inventors: Vinayaraj POLIYAPRAM, Tokyo (JP); Kyle MEDE, Tokyo (JP)

(73) Assignee: Rakuten Group, Inc., Tokyo (JP)

(21) Appl. No.: 19/281,943

(22) Filed: Jul. 28, 2025

(30) Foreign Application Priority Data
Jul. 30, 2024 (JP) 2024-122969

(51) Int. Cl. H04W 64/00; H04W 4/029

(52) U.S. Cl. CPC H04W 64/006; H04W 4/029

(57) ABSTRACT

An information processing apparatus generates a trajectory sequence of a user device that is moving, the trajectory sequence including at least one IP address of the user device and at least one piece of position information representing a region including a position of the user device, acquires an IP address of a target user device as a target IP address; and predicts position information corresponding to the target IP address by inputting the target IP address to a learning model for machine learning that has learned a correspondence relationship between IP addresses and position information using the trajectory sequence.

### CROSS-REFERENCE TO RELATED APPLICATION(S)

This application claims priority to Japanese patent application No. 2024-122969, filed on Jul. 30, 2024; the entire contents of which are incorporated herein by reference.

### TECHNICAL FIELD

The present invention relates to a technology for predicting position information regarding a device from the IP address of the device.

### BACKGROUND ART

Position information regarding a device such as a user terminal can be identified using existing position detection technology, such as a global positioning system (GPS). However, when such a position detection technology is not utilized, it is difficult to identify the device position. When utilizing communication from a device via the internet, an Internet Protocol (IP) address is assigned to the device. Thus, identifying position information regarding the device based on the IP address is an effective means. However, an IP address and position information regarding a device that uses the IP address, that is, position information corresponding to the IP address, are basically not associated with each other.

In recent years, technologies have been developed for predicting position information corresponding to an IP address assigned to a device based on the IP address. For example, JP 2022-172572A discloses predicting (estimating) position information corresponding to an IP address whose position information is unknown, using an access log including IP addresses whose position information is known.

JP 2022-172572A is an example of related art.

### SUMMARY OF THE INVENTION

According to the technology of JP 2022-172572A, it is possible to predict position information corresponding to an IP address whose position information is unknown, using an access log including IP addresses whose position information is known. However, since a vast number of IP addresses may be used, processing for collecting the access log including IP addresses whose position information is known and processing for predicting position information corresponding to an IP address whose position information is unknown based on the access logs can be complex. Accordingly, there is a demand for a technology for more efficiently predicting position information corresponding to an IP address from the IP address.

The present invention has been made in view of the foregoing problem, and aims to provide a technology for efficiently predicting position information corresponding to an IP address from the IP address.

To solve the above problem, one aspect of an information processing apparatus according to the present invention includes: a generation unit configured to generate a trajectory sequence of a user device that is moving, the trajectory sequence including at least one IP address of the user device and at least one piece of position information representing a region including a position of the user device; an acquisition unit configured to acquire an IP address of a target user device as a target IP address; and a prediction unit configured to predict position information corresponding to the target IP address by inputting the target IP address to a learning model for machine learning that has learned a correspondence relationship between IP addresses and position information using the trajectory sequence.

To solve the above problem, one aspect of an information processing method according to the present invention includes: generating a trajectory sequence of a user device that is moving, the trajectory sequence including at least one IP address of the user device and at least one piece of position information representing a region including a position of the user device; acquiring an IP address of a target user device as a target IP address; and predicting position information corresponding to the target IP address by inputting the target IP address to a learning model for machine learning that has learned a correspondence relationship between IP addresses and position information using the trajectory sequence.

To solve the above problem, one aspect of an information processing program according to the present invention is a program for causing a computer to execute: generation processing for generating a trajectory sequence of a user device that is moving, the trajectory sequence including at least one IP address of the user device and at least one piece of position information representing a region including a position of the user device; acquisition processing for acquiring an IP address of a target user device as a target IP address; and prediction processing for predicting position information corresponding to the target IP address by inputting the target IP address to a learning model for machine learning that has learned a correspondence relationship between IP addresses and position information using the trajectory sequence.

According to the present invention, it is possible to efficiently predict position information corresponding to an IP address from the IP address.

A person skilled in the art will be able to understand the above-stated object, aspect, and advantages of the present invention, as well as other objects, aspects, and advantages of the present invention that are not mentioned above, from the following modes for carrying out the invention by referring to the accompanying drawings and claims.

### BRIEF DESCRIPTION OF THE DRAWINGS

FIG. 1 shows an example configuration of an information processing system according to an embodiment.

FIG. 2 shows an example functional configuration of an information processing apparatus according to the embodiment.

FIG. 3A shows an example of a map including a plurality of regions to which geodata is assigned.

FIG. 3B shows a specific example of encoding position data into geodata.

FIG. 4A is a diagram for illustrating individual tokenization processing.

FIG. 4B is a diagram for illustrating multilingual tokenization processing.

FIG. 5 is a concept diagram of pre-training processing for a natural language model.

FIG. 6 shows a flowchart of training processing performed by the information processing apparatus.

FIG. 7 is a flowchart of position information or IP address prediction processing performed by the information processing apparatus.

FIG. 8 shows an example hardware configuration of the information processing apparatus according to the embodiment.

### EMBODIMENTS OF THE INVENTION

Embodiments of the present invention will now be described in detail with reference to the accompanying drawings. Out of the component elements described below, elements with the same functions have been assigned the same reference numerals, and description thereof is omitted. Note that the embodiments disclosed below are mere example implementations of the present invention, and it is possible to make changes and modifications as appropriate according to the configuration and/or various conditions of the apparatus to which the present invention is to be applied. Accordingly, the present invention is not limited to the embodiments described below. The combination of features described in these embodiments may include features that are not essential when implementing the present invention.

### Configuration of Information Processing System

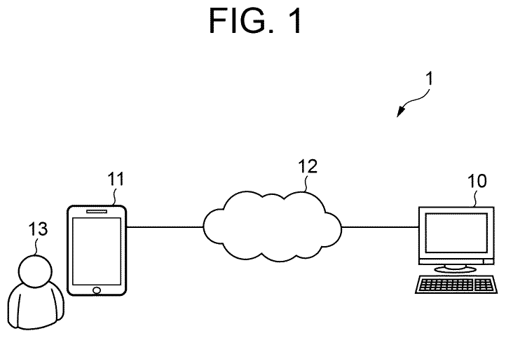

FIG. 1 shows an example configuration of an information processing system 1 according to the present embodiment. The information processing system 1 includes an information processing apparatus 10 and a user device (user equipment: UE) 11. The information processing apparatus 10 and the user device 11 can communicate with each other via a network 12. The network 12 can include a local area network (LAN), a wide area network (WAN), and a wired or wireless network such as a mobile communication network. Note that, while one user device 11 is shown in FIG. 1, the information processing system 1 may be configured such that a plurality of user devices including the user device 11 can communicate with the information processing apparatus 10 via the network 12. The user device 11 is operated by a user 13. In the present disclosure, the terms “user device” and “user” may be understood to be interchangeable.

The user device 11 is a mobile terminal carried by the user 13, and the user device 11 moves as the user 13 moves. The user device 11 is, for example, a device such as a smartphone or a tablet, and is configured to be capable of communicating with the information processing apparatus 10 via the network 12. The information processing apparatus 10 is an apparatus that processes information received from the user device 11. The information processing apparatus 10 may be a server device that provides an electronic commerce platform, such as an online marketplace, and the user device 11 may be configured to utilize a web service (internet-related service) provided by the information processing apparatus 10.

The user device 11 includes a positioning unit capable of acquiring position data such as coordinate data that indicates the position of the user device 11 in a predetermined coordinate system (map). The positioning unit is, for example, a global positioning system (GPS) sensor, and the position data may be constituted by a latitude and a longitude. The user device 11 acquires a plurality of consecutive pieces of position data along movement of the user 13, and transmits the acquired position data to the information processing apparatus 10 in association with a user identifier identifying the user device 11. In the following description, an identifier identifying a user device is referred to as a user ID. Also, the user device 11 may transmit the position data to the information processing apparatus 10 with time information (timestamp) indicating the time when the position data was acquired attached to the position data. The user device 11 may acquire position data at regular intervals or at predetermined timings. The timing for acquiring position data may be indicated by another device, such as the information processing apparatus 10. Note that the user device 11 may transmit position data attached with time information to an external device other than the information processing apparatus 10 via the network 12.

The user device 11 transmits an Internet Protocol (IP) address of the user device 11, i.e., an IP address assigned to the user device 11, to the information processing apparatus 10 in association with the user ID of the user device 11. The user device 11 may transmit the IP address to the information processing apparatus 10 at predetermined intervals or at predetermined timings. The user device 11 may attach to the IP address time information (timestamp) regarding the time when the user device 11 utilizes communication using the IP address via the internet, and transmit it to the information processing apparatus 10.

The IP address is numerical data consisting of a predetermined number of bits assigned to a device when the device utilizes communication via the internet, and is constituted by a network address section representing a relevant network and a host address section representing a relevant device (host). IP addresses assigned to a device are classified into a dynamic IP address that is dynamically assigned to the device and a fixed IP address that is fixedly assigned to the device. In the case of a dynamic IP address, for example, when the user device 11 connects to the internet, an IP address that is not used at that point in time is automatically assigned to the user device 11 from the internet service provider (ISP) with which the user 13 has a contract. Meanwhile, in the case of a fixed IP address, for example, when the user device 11 connects to the internet, the same IP address is always assigned to the user device 11 from the ISP with which the user 13 has a contract. In the present embodiment, it is assumed that the dynamic IP address is used. Note that the present embodiment can also be applied to the case where the IP address is assigned to a device by another method.

The ISP owns a large number of access points (AP) provided in a large number of areas and manages a large number of IP addresses for each access point. Thus, the IP address assigned by the ISP may have a certain relationship with the geographical location. The position of the user device 11 may vary as the user 13 moves, and the access point to which the user device 11 connects may also vary accordingly. Thus, the IP address assigned to the user device 11 may also vary. The user device 11 may transmit information regarding the IP address being used at that point in time to the information processing apparatus 10 at predetermined intervals or at predetermined timings.

As mentioned above, the information processing apparatus 10 may be a server device that provides an electronic commerce platform, and the user device 11 can utilize a web service (internet-related service) provided by the information processing apparatus 10. Note that the information processing apparatus 10 is not limited to the aforementioned server device, and the user device 11 may use a web service provided by a server device (not shown) different from the information processing apparatus 10, via the information processing apparatus 10. Examples of web services may include an online mall, an online supermarket, and electronic commerce (EC) services related to communication, finance, real estate, sports, and travel. These web services can be utilized by the user 13, for example, by logging in an application programming interface (API) provided by the information processing apparatus 10 or other devices with an account of the user 13. The user device 11 may transmit, via a web service, position data and/or an IP address associated with the user ID and time information to the information processing apparatus 10.

The information processing apparatus 10, upon receiving position data and an IP address associated with each user ID from a plurality of user devices including the user device 11, encodes the position data and generates geodata as position information (which may also be referred to as region information or area information) representing a region including the position indicated by the position data. The information processing apparatus 10 then stores the generated geodata and IP address in association with the user ID. Also, the information processing apparatus 10 trains a natural language model 241 to associate geodata with IP addresses based on the stored geodata and IP addresses (i.e., to identify the correspondence relationship between IP addresses and position information, such as patterns of the geodata corresponding to IP addresses and their relationships). Further, when receiving an IP address from a target user device, the information processing apparatus 10 predicts geodata corresponding to the received IP address as position information corresponding to the IP address using the trained natural language model 241. In the present disclosure, the terms “geodata” and “position information” may be understood to be interchangeable.

### Functional Configuration of Information Processing Apparatus

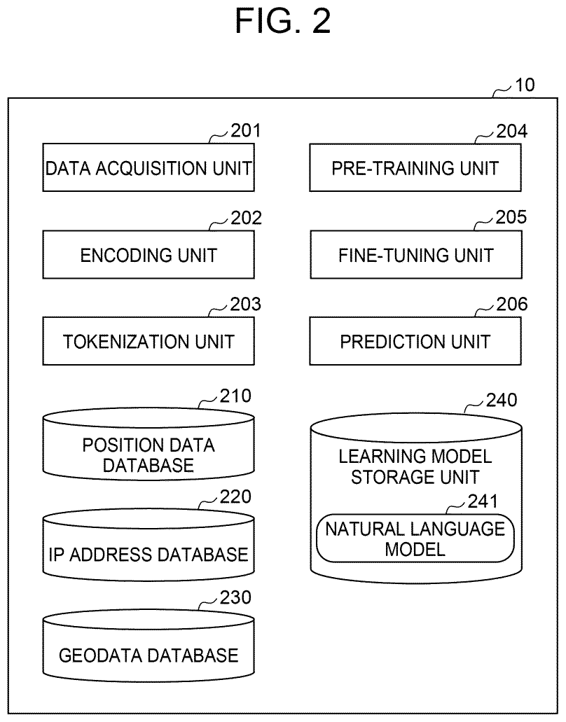

FIG. 2 shows an example of a functional configuration of the information processing apparatus 10 according to the present embodiment. The information processing apparatus 10 includes, in an example of its functional configuration, a data acquisition unit 201, an encoding unit 202, a tokenization unit 203, a pre-training unit 204, a fine-tuning unit 205, a prediction unit 206, a position data database 210, an IP address database 220, a geodata database 230, and a learning model storage unit 240. The learning model storage unit 240 is capable of storing the natural language model 241. Since the pre-training unit 204 and the fine-tuning unit 205 are functional constituents for training the natural language model 241, they may be integrated into one functional constituent.

The natural language model 241 is, for example, a Transformer-based natural language processing model, e.g., a learning model for Bidirectional Encoder Representations from Transformers (BERT)-based machine learning. The natural language model 241 is a learning model configured to extract features of input language information (e.g., by encoding it), generate a feature vector (also referred to as an embedding vector) representing the features of the language information, and enables generation of final output data (also referred to as an output value) from the feature vector. In the learning model storage unit 240, various parameters derived from the architecture of the natural language model 241 and the training (including pre-training and fine-tuning) may be stored.

Note that the entire information processing apparatus 10 need not necessarily be one device, and may alternatively be constituted by a plurality of devices. For example, a portion of the information processing apparatus 10 may be provided in an external server device. In this case, the following functions are realized by cooperation of the information processing apparatus 10 and the external server device.

The data acquisition unit 201 acquires various data from a plurality of user devices including the user device 11. For example, the data acquisition unit 201 acquires position data and an IP address associated with the user ID of each user device from a plurality of user devices including the user device 11. The position data acquired from the user device 11 corresponds to coordinate data indicating the position of the user device 11 in a predetermined coordinate system, and is attached with time information regarding the time when the coordinate data was acquired by the user device 11. In the present embodiment, the position data is assumed to be data including a latitude and a longitude. Alternatively, the position data may be data indicating a position specified by any coordinates on a map.

The IP address acquired from the user device 11 corresponds to the IP device assigned to the user device 11, and is attached with time information regarding the time when the IP address is used by the user device 11. The timing at which the data acquisition unit 201 acquires the position data and the IP address may be the same, but need not necessarily be the same. Further, the data acquisition unit 201 may acquire, from a plurality of user devices including the user device 11, the position data and IP addresses associated with the user ID of each user device via another device, rather than directly from the user devices.

The data acquisition unit 201 stores the acquired position data in the position data database 210, and stores the acquired IP address in the IP address database 220. Thus, the position data associated with the user IDs of the plurality of user devices are stored in order together with the time information in the position data database 210, and the IP addresses associated with the user IDs of the plurality of user devices are successively stored in order with the time information in the IP address database 220.

The encoding unit 202 encodes (i.e., converts) each piece of the position data stored in the position data database 210 into a character string representing a region including the position indicated by the position data. In the present embodiment, the character string corresponds to geodata. Each character constituting geodata may follow any format. In the present embodiment, the encoding unit 202 encodes position data into geodata using a plurality of regions preset on a map. The plurality of regions correspond to a plurality of sections obtained by dividing the map into a grid, and geodata is assigned to each of the plurality of regions based on geographical location. The encoding unit 202 encodes each piece of position data into geodata assigned to a region including the position (e.g., the latitude and longitude of the position) indicated by the piece of position data. That is, the encoding unit 202 generates geodata by mapping each piece of position data to one of the plurality of regions.

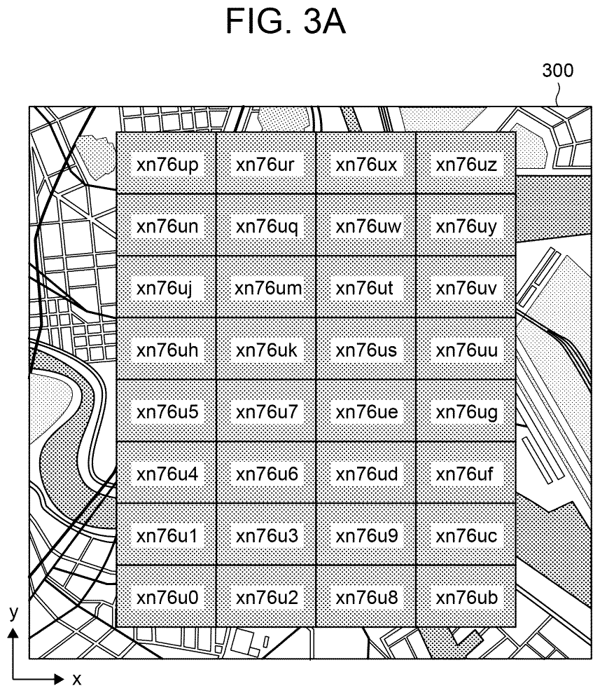

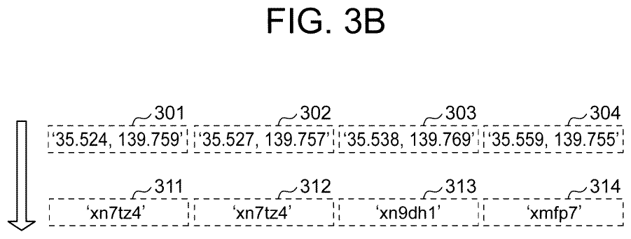

FIG. 3A shows an example of a map 300 including a plurality of regions to which geodata is assigned. The map 300 includes 32 regions. In FIG. 3A, a geohash is used as an example of geodata assigned to each region. A geohash is an example of hashed position information. In this example, a geohash6, which is a six-digit geohash, is used. The hashed position information is position information that can be obtained by inputting, to a hash function, data (e.g., the latitude and longitude) on a predetermined position (e.g., center position) in each region as an argument (input value). That is, each piece of geodata is information obtained by inputting, to a hash function, data on a predetermined position in the region represented by the geodata (i.e., in the region corresponding to the geodata) as an argument.

A geohash6 used in the present embodiment consists of six digits (i.e., six characters). As an example, each region represented by a geohash6 consists of a rectangle with a dimension in the east-west (x) direction of 1.2 kilometers (km) and a dimension in the north-south (y) direction of 906 meters (m). Note that, here, the dimensions in the x and y directions and the size (e.g., the area) of each region are not limited to specific numerical values, but each of them is in a range larger than the position indicated by position data.

The plurality of characters that constitute geodata consist of a plurality of blocks corresponding to a plurality of hierarchical geographical areas (from large division areas to small division areas). Here, one or more common (i.e., the same) characters are used for common geographical areas. For example, character strings corresponding to the same numeric portions of the latitude and longitude are represented by one or more common characters.

In the example in FIG. 3A, the 32 regions shown in the figure form the same large division (large-sized) area as a whole, and the characters “xn76u” are applied to this large division area. Therefore, the 32 regions are all prefixed with the characters “xn76u”. Also, each of the 32 regions forms a small division (small-sized) area, and different characters are applied to each region. Specifically, to the 32 respective regions, the characters “0”, “1”, “2”, “3”, “4”, “5”, “6”, “7”, “8”, “9”, “b”, “c”, “d”, “e”, “f”, “g”, “h”, “j”, “k”, “m”, “n”, “p”, “q”, “r”, “s”, “t”, “u”, “v”, “w”, “x”, “y”, and “z” are applied following “xn76u”. In this way, in the example in FIG. 3A, the geodata assigned to each region is constituted by two blocks.

Thus, geodata consists of six characters as shown in FIG. 3A. In other words, geodata realizes position information utilizing six-level accuracy. As mentioned above, in the present embodiment, each region to which geodata is assigned has the size represented by a geohash6 (as an example, 1.2 km×906 m). Geodata is data having a higher resolution (i.e., larger granularity) than position data (latitude and longitude in the present embodiment) acquired by the user device 11, and geodata can be considered as information with a sufficiently effective resolution as information indicating the position of the user device 11 that is to be determined, for example, in order to provide a web service. For example, in the case of providing weather information as a web service, it is sufficient that the region of the size represented by a geohash6 where the user device 11 is located can be determined, even if the position of the user device 11 cannot be accurately determined.

Note that the region to which a piece of geodata is assigned may be larger or smaller than the size represented by a geoohash6. The smaller the region to which each piece of geodata is assigned, the longer the character string that constitutes it. That is, geodata with more digits can represent a smaller region, while geodata with fewer digits can represent a larger region. In FIG. 3A, each region is constituted by a rectangle represented by a geohash6, but the shape of the region represented by geodata is not limited thereto. For example, the shape of the region represented by geodata may alternatively be another polygon or shape such as a pentagon or hexagon.

FIG. 3B shows a specific example of encoding position data into geodata. In FIG. 3B, position data 301 to position data 304 are position data each of which is constituted by a latitude and a longitude, with time information and user ID information omitted. The encoding unit 202 generates geodata 311 to geodata 314 by encoding each of the position data 301 to the position data 304 into a geodata assigned to a region including the position indicated by the position data (e.g., one of the rectangular regions shown in FIG. 3A). Position data 301=‘35.524, 139.759’ and position data 302=‘35.527, 139.757’ are encoded into geodata 311=geodata 312=‘xn7tz4’. This equates to the position of latitude=35.524 and longitude=139.759 and the position of latitude=35.527 and longitude=139.757 being located in the same region (the same rectangular region in the example in FIG. 3A) on the map. Meanwhile, position data 303=‘35.538, 139.769’ is encoded into geodata 313=‘xn9dh1’, and position data 304=‘35.559, 139.755’ is encoded into geodata 314=‘xmfp7’. Thus, the position data 303 and the position data 304 are encoded into different geodata. This equates to the position of latitude=35.538 and longitude=139.769 and the position of latitude=35.559 and longitude=139.755 being located in different regions (different rectangular regions in the example in FIG. 3A) on the map.

The encoding unit 202 may generate geodata by bringing one or more pieces of position data with time information within a predetermined time together into one piece of position data. Alternatively, the encoding unit 202 may generate one piece of geodata by bringing together one or more pieces of geodata with time information within a predetermined time, among the encoded geodata. The encoding unit 202 stores the generated geodata in the geodata database 230. As a result of the encoding unit 202 encoding the position data stored in the position data database 210 into geodata in order in accordance with the time information, the geodata associated with the user IDs of the plurality of user devices are successively stored together with the time information in the geodata database 230.

Returning to the description of FIG. 2, the tokenization unit 203 acquires the IP address and geodata associated with a user ID (history data associated with the user ID) from the IP address database 220 and the geodata database 230, respectively, processes the acquired IP address and geodata, and generates a trajectory sequence that represents features of movement of the user device corresponding to the user ID. Specifically, the tokenization unit 203 tokenizes consecutive IP addresses stored in the IP address database 220 and generates an IP address token from each IP address. The tokenization unit 203 also tokenizes consecutive geodata stored in the geodata database 230 and generates a geodata token from each piece of geodata. Then, the tokenization unit 203 generates a trajectory sequence constituted by a plurality of tokens (including IP addresses and/or geodata). The trajectory sequence includes at least one IP address. Similar to conventional tokenization processing, the tokenization unit 203 may insert a special token such as “[UNK]”, “[PAD]”, “[CLS]”, or “[SEP]” into the trajectory sequence. The generated trajectory sequence corresponds to training data for training the natural language model 241. The IP address and the geodata have different language formats, and can therefore be considered as different languages. Accordingly, the tokenization unit 203 that processes the IP address and the geodata together functions as a multilingual tokenizer that realizes multilingual tokenization.

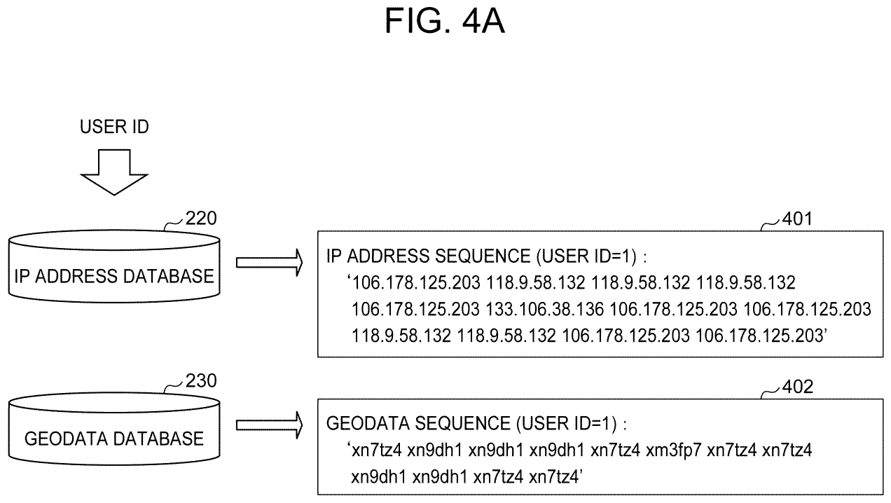

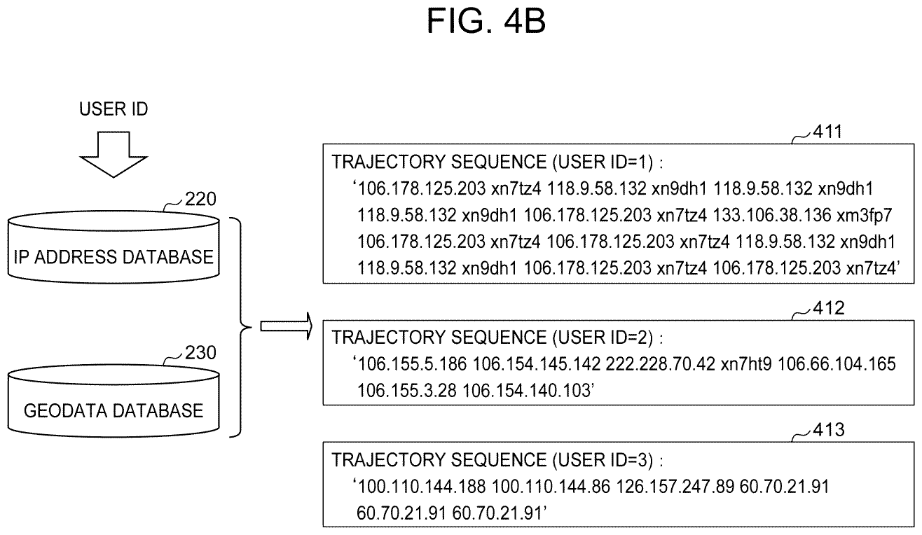

To describe the processing performed by the tokenization unit 203 that functions as a multilingual tokenizer, first, individual tokenization processing for individually tokenizing an IP address and geodata is described with reference to FIG. 4A. In this case, the tokenization unit 203 functions as an individual tokenizer. FIG. 4A is a diagram for illustrating the individual tokenization processing. The tokenization unit 203 designates a user ID and acquires, from the IP address database 220, consecutive IP addresses associated with the designated user ID and attached with time information within a predetermined time range (e.g., one hour or one week). The user ID may be designated, for example, by the tokenization unit 203 in accordance with a predetermined program, or by an operator of the information processing apparatus 10. In the example in FIG. 4A, the designated user ID is user ID=1. Then, the tokenization unit 203 generates an IP address sequence 401 including a plurality of IP addresses by partitioning, with a blank, the IP addresses that have been tokenized from the acquired consecutive IP addresses, and arranging the IP addresses in order in accordance with the time information. Similarly, the tokenization unit 203 acquires consecutive pieces of geodata associated with user ID=1 and attached with time information within a predetermined time range from the geodata database 230. Then, the tokenization unit 203 generates a geodata sequence 402 including a plurality of pieces of geodata by partitioning, with a blank, the pieces of geodata that have been tokenized from the acquired consecutive pieces of geodata, and arranging the pieces of geodata in order in accordance with the time information. The IP address sequence 401 and the geodata sequence 402 represent changes in the IP address and changes in the geodata, respectively, as features of movement of user ID=1.

In FIG. 4A, for illustration, the IP address sequence 401 and the geodata sequence 402 each include the same number of tokens, and the time information attached to the respective tokens indicates the same time period. Note that the term “same time period” in the present embodiment represents a time range including the same time or close times (e.g., times that differ by no more than 10 minutes). Thus, the first IP address in IP address sequence 401=‘106.178.105.203’ and the first geodata in geodata sequence 402=‘xn7tz4’ correspond to an IP address and geodata in the same time period. That is, the geodata corresponding to IP address=‘106.178.105.203’ is geodata=‘xn7tz4’. In this way, an n-th IP address in the IP address sequence 401 corresponds to an n-th geodata in the geodata sequence 402 (n ranges from 1 to N (the number of IP addresses included in IP address sequence 401=the number of pieces of geodata included in the geodata sequence 402)).

Next, processing performed by the tokenization unit 203 that functions as a multilingual tokenizer is described. FIG. 4B is a diagram for illustrating multilingual tokenization processing according to the present embodiment. The tokenization unit 203 designates a user ID and acquires, from the IP address database 220 and the geodata database 230, consecutive IP addresses and geodata that are associated with the designated user ID and attached with time information within a predetermined time range (e.g., one hour or one week). Next, the tokenization unit 203 tokenizes the consecutive IP addresses and generates an IP address token from each IP address, and also tokenizes the consecutive geodata and generates a geodata token from each piece of geodata. Thus, one or more tokenized IP addresses and one or more pieces of tokenized geodata are generated. Then, the tokenization unit 203 generates a trajectory sequence by arranging a plurality of tokens (IP addresses and/or geodata) while partitioning the tokens with a blank. The user ID may be designated, for example, by the tokenization unit 203 in accordance with a predetermined program, or by an operator of the information processing apparatus 10.

FIG. 4B shows a trajectory sequence 411, a trajectory sequence 412, and a trajectory sequence 413 as examples of trajectory sequences generated by the tokenization unit 203. The trajectory sequence 411 is a trajectory sequence of a user with user ID=1, the trajectory sequence 412 is a trajectory sequence of a user with user ID=2, and the trajectory sequence 413 is a trajectory sequence of a user the with user ID=3. The trajectory sequence 411 is a trajectory sequence of the user with user ID=1, in which the IP addresses and geodata included in the IP address sequence 401 and the geodata sequence 402 shown in FIG. 4A are arranged such that the IP address and the geodata from the same time period are consecutive. For example, in the trajectory sequence 411, IP address=‘106.178.105.203’ and geodata=‘xn7tz4’ attached with time information of the same time period are arranged consecutively. In the trajectory sequence 411, the IP address is placed before the geodata, of the IP address and geodata from the same time period, but the geodata may be placed before the IP address.

In the trajectory sequence 411, the IP addresses and the geodata are in one-to-one correspondence for the same time period. That is, the user device corresponding to user ID=1 can acquire position data serving as the basis of the geodata in the time period in which the user devices uses the IP address, and transmit the position data to the information processing apparatus 10. Meanwhile, it is also possible that the user device temporarily deactivates the positioning unit, and the position data cannot be acquired temporarily. In such a case, the trajectory sequence is not generated such that one piece of geodata always corresponds to one IP address. That is, the geodata is partially missing from the trajectory sequence. The trajectory sequence 412 is a trajectory sequence in which geodata is partially missing, and has only one geodata=‘xn9dh1’. In addition, it is also possible that the user device deactivates a position data detection function, and no position data can be acquired at all. In such a case, the trajectory sequence is not generated such that one piece of geodata corresponds to one IP address. The trajectory sequence 413 is a trajectory sequence that does not contain geodata, and consists only of IP addresses.

In this way, the tokenization unit 203 generates a plurality of trajectory sequences each of which includes at least IP addresses. Each trajectory sequence may have features of changes in IP addresses used by each user device along with its movement. The pre-training unit 204 causes the natural language model 241 to learn the relationship between the IP address and geodata (the correspondence relationship between the IP address and position information), so it is optimal to perform training using the trajectory sequence 411 in which the IP addresses and the geodata from the same time period are in one-to-one correspondence.

Note that the tokenization unit 203 in the present embodiment performs multilingual tokenization processing on the IP addresses and the geodata, while the tokenization unit 203 may be configured to tokenize each data piece for a data group including a plurality of data pieces having different language formats.

The pre-training unit 204 pre-trains the natural language model 241 using the trajectory sequence generated by the tokenization unit 203. The natural language model 241 is, for example, a Transformer-based natural language processing model, e.g., a Bidirectional Encoder Representations from Transformers (BERT)-based machine learning model. The natural language model 241 may be a DistilBERT-based machine learning model that is faster/lighter than the conventional BERT.

In the present embodiment, the pre-training unit 204 trains the natural language model 241 through the self-supervised learning strategy using a masked language model (MLM) methodology. That is, training processing can be performed in a self-contained manner using the trajectory sequence generated by the tokenization unit 203, without using correct answer data (ground truth) of position information provided by other businesses or third parties.

Specifically, the pre-training unit 204 intentionally masks some of the tokens in the trajectory sequence generated by the tokenization unit 203, and inputs the trajectory sequence with some tokens masked to the natural language model 241. For example, the tokenization unit 203 replaces each token to be masked with [MASK]. The natural language model 241 extracts features of each of the plurality of tokens included in the trajectory sequence with some tokens masked and generates a feature vector of each token. The pre-training unit 204 then trains the natural language model 241 to perform a task of predicting feature vectors of the masked tokens and predicting the masked tokens (i.e., masked portions). The pre-training unit 204 may randomly determine one or more tokens to be masked in the trajectory sequence. Alternatively, one or more tokens to be masked in the trajectory sequence may be determined by an operator of the information processing apparatus 10 or an external device.

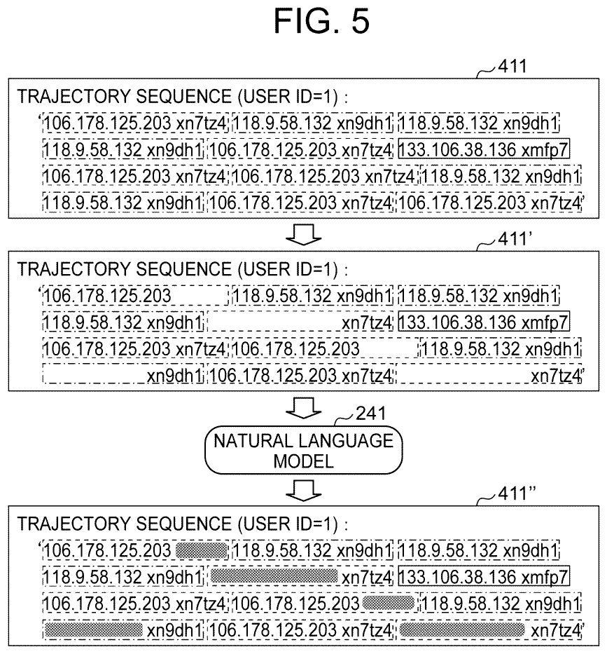

FIG. 5 is a diagram showing a concept of pre-training processing performed on the natural language model 241 performed by the pre-training unit 204. For illustration, the trajectory sequence 411 shown in FIG. 4B is used. For illustration, in the trajectory sequence 411, IP addresses and geodata attached with time information of the same time period are enclosed by lines of the same type. For example, IP address=‘106.178.125.203’ and geodata=‘xn7tz4’ are attached with time information included in the same time period and are enclosed by a broken line. IP address=‘118.9.58.132’ and geodata=‘xn9dh1’ are attached with time information included in the same time period and are enclosed by a dashed line. IP address=‘133.106.38.136’ and geodata=‘xm3fp7’ are attached with time information included in the same time period and are enclosed by a solid line.

The pre-training unit 204 generates a trajectory sequence 411′ with some tokens masked, which is the trajectory sequence 411 in which some tokens (IP addresses or geodata) are masked. In the trajectory sequence 411′, a plurality of random or predetermined tokens are masked. The pre-training unit 204 inputs the trajectory sequence 411′ to the natural language model 241 and trains the natural language model 241 to predict the plurality of masked tokens. In FIG. 5, the natural language model 241 to which the trajectory sequence 411′ is input outputs a trajectory sequence 411″, and the results of predicting the masked tokens (predicted tokens) in the trajectory sequence 411′ are shaded. The pre-training unit 204 trains the natural language model 241 by comparing the trajectory sequence 411″ with the trajectory sequence 411.

Thus, the natural language model 241 learns the relationship of geodata with respect to IP addresses from the same time period in the trajectory sequence 411, and the relationship of IP addresses with respect to geodata from the same time period. By performing such pre-training using a plurality of trajectory sequences, the natural language model 241 learns geodata corresponding to IP addresses and IP addresses corresponding to geodata.

The performance of the natural language model 241 is evaluated based on the accuracy of predicting the masked tokens. Since correct answer tokens are obtained from the trajectory sequence generated by the tokenization unit 203, parameters, weights, and the like of the natural language model 241 are updated so as to maximize the accuracy by comparing the masked tokens with the correct answer tokens corresponding to the masked tokens. By continuously performing the above task and evaluation, the capability to learn contextual relationships between the tokens in the trajectory sequence can be improved. The contextual relationships between the tokens include the mutual relationship between IP addresses and geodata (geodata corresponding to IP addresses and IP addresses corresponding to geodata).

The fine-tuning unit 205 fine-tunes the natural language model 241 that has been pre-trained by the pre-training unit 204. In the present embodiment, fine-tuning is performed by means of a contrastive fine-tuning technique using correct answer data. Specifically, first, the fine-tuning unit 205 generates a correct answer data pair from the IP address database 220 and the geodata database 230. For example, the fine-tuning unit 205 acquires, from the IP address database 220 and the geodata database 230, an IP address of a random user (also referred to as a reference IP address) and geodata corresponding to this IP address (also referred to as reference geodata), and generates a correct answer data pair of the IP address and geodata. The fine-tuning unit 205 inputs the IP address of the correct answer data pair to the natural language model 241, generates a feature vector of the IP address (hereinafter referred to as an IP address feature vector), and embeds the generated IP address feature vector in a common vector space. Further, the fine-tuning unit 205 inputs the geodata of the correct answer data pair to the natural language model 241, generates a feature vector of the geodata (hereinafter referred to as a geodata feature vector), and embeds the generated geodata feature vector in the common vector space. Then, the fine-tuning unit 205 trains the natural language model 241 to reduce, preferably minimize, the distance between the IP address feature vector and the geodata feature vector embedded in the common vector space. If the distance between the feature vectors embedded in the common vector space is short, it means that the features represented by those feature vectors are highly related.

The fine-tuning unit 205 can calculate the distance between the feature vectors in the common vector space as a cosine distance or a Euclid distance. The cosine distance corresponds to a cosine value (from −1 to +1) of an angle between two vectors in the common vector space. The Euclid distance corresponds to a normal distance, i.e., how far the two vectors in the common vector space are separated. The criteria for minimization and maximization (i.e., targeted training accuracy) may be set in any manner.

The fine-tuning unit 205 fine-tunes the natural language model 241 using a plurality of correct answer data pairs, thereby training the natural language model 241 such that a geodata feature vector that is more highly related to an IP address feature vector is placed closer to the IP address feature vector in the common vector space. This allows the natural language model 241 to identify a geodata feature vector closest to an IP address feature vector generated from an input IP address in the common vector space. The geodata corresponding to the identified geodata feature vector is output from the natural language model 241 as geodata corresponding to that IP address (i.e., geodata from the time period in which the IP address was used). Similarly, the fine-tuning allows the natural language model 241 to identify an IP address feature vector closest to a geodata feature vector generated from an input geodata in the common vector space. The IP address corresponding to the identified IP address feature vector is output from the natural language model 241 as an IP address corresponding to the geodata (i.e., an IP address from the time period in which the position data serving as the basis of the geodata was acquired). With this configuration, the natural language model 241 is configured to predict and output geodata corresponding to an input IP address, and predict and output an IP address corresponding to input geodata.

Moreover, the IP address can be changed or added daily. To predict the geodata corresponding to the IP address (and vice versa) more accurately, the fine-tuning unit 205 needs to continuously fine-tune, i.e., re-train, the natural language model 241 using correct answer data pairs. Thus, for example, the fine-tuning unit 205 generates correct answer data pairs of random users from the IP address database 220 and the geodata database 230, and continues to fine-tune the natural language model 241 using the correct answer data pairs. Instead of or in addition to this, the fine-tuning unit 205 may continue to fine-tune the natural language model 241 using a trajectory sequence including correct answer data pairs. This makes it possible to quickly follow changes in the IP address corresponding to position data, even if the IP address changes dynamically.

The prediction unit 206 predicts geodata corresponding to an IP address for predicting position information (hereinafter referred to as a target IP address) from this target IP address, using the natural language model 241 that has been fine-tuned by the fine-tuning unit 205. Specifically, the prediction unit 206 inputs a target IP address acquired from a random user device via the data acquisition unit 201 to the natural language model 241. The natural language model 241 outputs position information corresponding to the target IP address, and the prediction unit 206 predicts the output position information as the position information corresponding to the target IP address.

Further, the prediction unit 206 may also predict an IP address corresponding to position data for predicting an IP address (hereinafter referred to as target position data) from this target position data, using the natural language model 241 that has been fine-tuned by the fine-tuning unit 205. Specifically, the encoding unit 202 first encodes the target position data acquired from a random user device via the data acquisition unit 201 into geodata. Subsequently, the prediction unit 206 inputs this geodata to the natural language model 241. The natural language model 241 outputs an IP address corresponding to the geodata, and the prediction unit 206 predicts the output IP address as an IP address corresponding to the target position data.

Further, the prediction unit 206 may also predict an IP address corresponding to geodata for predicting an IP address (hereinafter referred to as target geodata) from this target geodata, using the natural language model 241 that has been fine-tuned by the fine-tuning unit 205. Specifically, the prediction unit 206 inputs the target geodata into the natural language model 241. The natural language model 241 outputs an IP address corresponding to the target geodata, and the prediction unit 206 predicts the output IP address as an IP address corresponding to the target geodata.

### Processing Flow

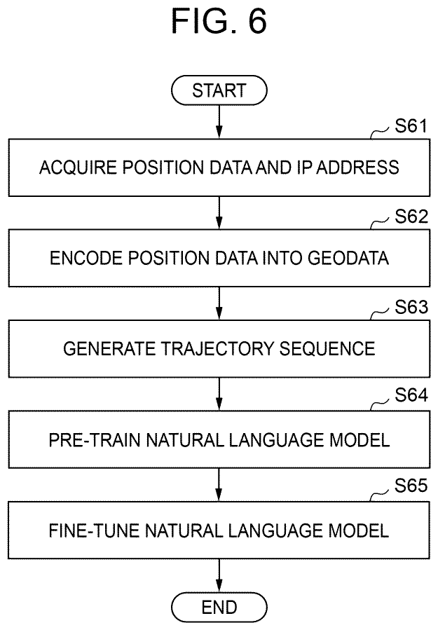

FIG. 6 shows a flowchart of the training processing performed by the information processing apparatus 10. Although interactions between the information processing apparatus and the user device 11 is described here with reference to FIG. 1, the same description can be applied to interactions between the information processing apparatus 10 and other user devices. The processing shown in FIG. 6 is performed after the user device 11 has been assigned an IP address to be used for communication, and the information processing apparatus has acquired position data on the user device 11 using the positioning unit.

In step S61, the data acquisition unit 201 acquires an IP address and position data (in the present embodiment, data including a latitude and a longitude) from the user device 11. The IP address and position data are associated with the user ID of the user device 11. Also, the IP address is attached with time information to be used for communication by the user device 11, and the position data is attached with time information acquired by the user device 11. The data acquisition unit 201 stores the acquired position data in the position data database 210, and stores the acquired IP address in the IP address database 220.

In step S62, the encoding unit 202 encodes (converts) the position data stored in the position data database 210 into geodata constituted by a character string. As described with reference to FIGS. 3A and 3B, the encoding unit 202 encodes the position data into geodata assigned to a region that includes the position indicated by the position data.

In step S63, the tokenization unit 203 generates one or more IP addresses and geodata associated with the user ID of the user device 11 by tokenizing consecutive pieces of data acquired from the IP address database 220 and the geodata database 230, respectively. Then, the tokenization unit 203 generates a trajectory sequence representing features of movement of the user device 11 using the generated one or more IP addresses and geodata. As described with reference to FIG. 4B, an example of the trajectory sequence is a sequence in which IP addresses and geodata attached with time information of the same time period are arranged in order, representing changes in the IP address and changes in the geodata as the features of the movement of the user device 11.

In step S64, the pre-training unit 204 pre-trains the natural language model 241, using the trajectory sequence generated by the tokenization unit 203. The pre-training unit 204 may pre-train the natural language model 241 using a large number of trajectory sequences generated using data acquired from a large number of user devices other than the user device 11. The pre-training unit 204 stores the pre-trained natural language model 241 in the learning model storage unit 240.

In step S65, the fine-tuning unit 205 fine-tunes the natural language model 241 that has been pre-trained by the pre-training unit 204. The fine-tuning unit 205 generates a correct answer data pair of an IP address of a random user and geodata corresponding to this IP address from the IP address database 220 and the geodata database 230. Then, the fine-tuning unit 205 inputs the IP address and the geodata of the correct answer data pair to the natural language model 241 to generate an IP address feature vector and a geodata feature vector, and fine-tunes the natural language model 241 so as to minimize the distance between those feature vectors in the common vector space. The fine-tuning unit 205 stores the fine-tuned natural language model 241 in the learning model storage unit 240. The fine-tuning unit 205 may regularly and continuously fine-tune the natural language model 241 and store the fine-tuned natural language model 241 in the learning model storage unit 240 each time the fine-tuning unit 205 performs fine-tuning. The fine-tuning unit 205 may continuously fine-tune the natural language model 241 using the correct answer data pair or a trajectory sequence including a correct answer data pair.

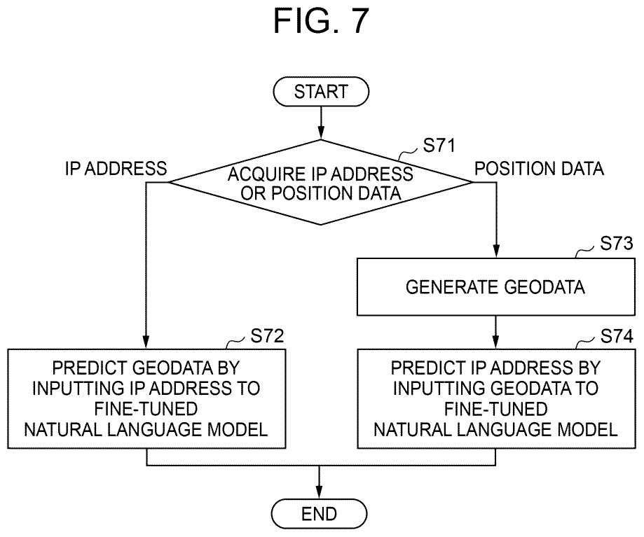

FIG. 7 is a flowchart of position information or IP address prediction processing performed by the information processing apparatus 10. Although interactions between the information processing apparatus 10 and the user device 11 will be described with reference to FIG. 1, the same description can be applied to interactions between the information processing apparatus 10 and other user devices. The processing shown in FIG. 7 is performed after the fine-tuned natural language model 241 is stored in the learning model storage unit 240. In step S71, the data acquisition unit 201 acquires, from the user device 11, a target IP address for predicting position information, or target position data for predicting an IP address. If a target IP address is acquired, processing proceeds to step S72, and if target position data is acquired, processing proceeds to step S73.

If the data acquisition unit 201 acquires a target IP address, in step S72, the prediction unit 206 predicts geodata corresponding to the target IP address by inputting the target IP address to the natural language model 241. That is, the prediction unit 206 predicts geodata output as a result of inputting the target IP address to the natural language model 241 as geodata corresponding to the target IP address. The prediction unit 206 may use the predicted geodata as position information corresponding to the IP address to provide a service, or may output the predicted geodata to an external device. For example, the information processing apparatus may provide a web service based on the position information to the user device 11. Also, the external device that has acquired the position information may similarly provide a web service based on the position information to the user device 11.

On the other hand, if the data acquisition unit 201 acquires target position data, in step S73, the encoding unit 202 generates geodata by encoding the target position data. In step S74, the prediction unit 206 predicts an IP address corresponding to the geodata by inputting the geodata to the natural language model 241. That is, the prediction unit 206 predicts an IP address output as a result of inputting the geodata to the natural language model 241 as an IP address corresponding to the geodata. The prediction unit 206 may use the predicted IP address to perform predetermined processing, or may output the predicted IP address to an external device.

As described above, the information processing apparatus 10 according to the present embodiment trains (pre-trains and fine-tunes) the natural language model 241 using an IP address of a user device and a trajectory sequence generated from position information (region information) based on position data (coordinate data indicating the position of the user device in a predetermined coordinate system). Then, the information processing apparatus 10 can predict position information corresponding to any IP address using the trained natural language model 241. Conversely, the information processing apparatus 10 can also predict an IP address corresponding to any position data using the trained natural language model 241. Since the IP address assigned to the user device can vary, the information processing apparatus continues to train the natural language model 241 using correct answer data, thereby making it possible to update the relationship between the IP address and position information based on the position data and perform prediction processing with high accuracy.

Further, the information processing apparatus 10 according to the present embodiment identifies IP addresses and position information as tokens using a database of IP addresses of user devices and a database of position information based on position data, and generates a trajectory sequence for training the natural language model 241. Although the IP addresses and position information have different language formats, the information processing apparatus can appropriately partition the tokens in accordance with the respective language formats and generate a trajectory sequence serving as training data suitable for training the natural language model 241.

Further, the information processing apparatus 10 according to the present embodiment can predict position information regarding the user device 11 from the IP address without acquiring position data provided by the GPS from the user device 11. Thus, the user device 11 can receive a service based on its position while deactivating its GPS function, which will lead to energy saving of the user device 11. Also, the position data provided by the GPS includes latitude and longitude data, and is data updated frequently in response to movement of the user device 11. Meanwhile, the IP address has a smaller data volume than the position data provided by the GPS and is data updated less frequently in response to movement of the user device 11. Therefore, the information processing apparatus 10 can predict position information of a size sufficient to provide a web service (in the present embodiment, a size represented by a geohash6) using position data with a small data volume and a low update frequency. Furthermore, the processing load for predicting position information can be reduced, and the processing efficiency increases.

### Hardware Configuration of Information Processing Apparatus

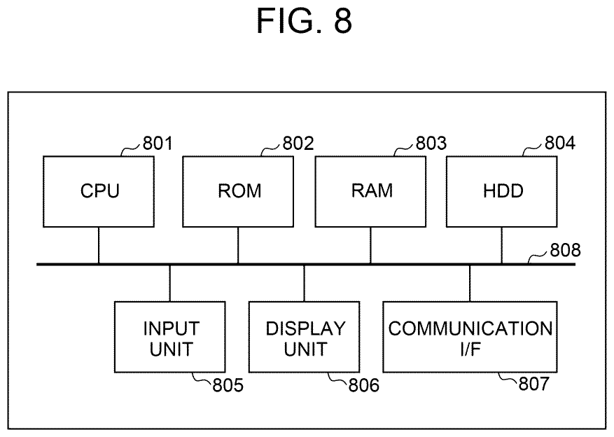

Next, an example hardware configuration of the information processing apparatus 10 is described. FIG. 8 is a block diagram showing an example of a hardware configuration of the information processing apparatus 10 according to the present embodiment.

The information processing apparatus 10 according to the present embodiment can be implemented on one or a plurality of any computer, mobile device, or any other processing platform.

Referring to FIG. 8, an example is shown in which the information processing apparatus 10 is implemented on a single computer, but the information processing apparatus 10 according to the present embodiment may be implemented on a computer system that includes a plurality of computers. The plurality of computers may be connected to each other communicatively by a wired or wireless network.

As shown in FIG. 8, the information processing apparatus 10 may include a central processing unit (CPU) 801, a read only memory (ROM) 802, a random access memory (RAM) 803, a hard disk drive (HDD) 804, an input unit 805, a display unit 806, a communication I/F (communication unit) (interface) 807, and a system bus 808. The information processing apparatus 10 may also be provided with an external memory.

The CPU 801 functions to perform overall control of the operations of the information processing apparatus 10, and controls the constituent units (802 to 807) via the system bus 808, which is a data transmission path.

The ROM 802 is a non-volatile memory that stores control programs and the like necessary for the CPU 801 to perform processing. The programs include instructions (code) for performing processing according to the above embodiment. Note that the programs may also be stored in a non-volatile memory such as the HDD 804 or a solid state drive (SSD) or in an external memory such as a removable storage medium (not shown).

The RAM 803 is a volatile memory and functions as a main memory, a work area, and the like of the CPU 801. That is, the CPU 801 realizes various functional operations by loading necessary programs and the like into the RAM 803 from the ROM 802 to perform processing, and executing the loaded programs and the like. The RAM 803 may include the position data database 210, the IP address database 220, the geodata database 230, and the learning model storage unit 240 shown in FIG. 2.

The HDD 804 stores various data, information and the like necessary when the CPU 801 performs processing using programs, for example. Also, the HDD 804 stores, for example, various data, information, and the like obtained by the CPU 801 performing processing using programs and the like.

The input unit 805 is constituted by a keyboard, a pointing device such as a mouse, or the like.

The display unit 806 is constituted by a monitor such as a liquid crystal display (LCD). The display unit 806 may also function as a graphical user interface (GUI) by being configured in combination with the input unit 805.

The communication I/F 807 is an interface that controls communication between the information processing apparatus 10 and external devices. The communication I/F 807 provides an interface with a network and performs communication with the external devices via the network. Various data, parameters, and the like are transmitted to and received from the external devices via the communication I/F 807. In the present embodiment, the communication I/F 807 may perform communication via a wired local area network (LAN) or a dedicated line conforming to a communication standard such as Ethernet (registered trademark). The network that can be used in the present embodiment is, however, not limited thereto and may be constituted by a wireless network. Examples of wireless networks include wireless personal area networks (PANs) such as Bluetooth (registered trademark), ZigBee (registered trademark), and ultra wide bands (UWBs). Examples of wireless networks also include wireless local area networks (LANs) such as Wireless Fidelity (Wi-Fi) (registered trademark) and wireless metropolitan area networks (MANs) such as WiMAX (registered trademark). Examples of wireless networks also include wireless wide area networks (WANs) such as 4G and 5G. Note that the network need only be capable of communicably connecting the devices to each other and enabling communication, and the standard, scale, and configuration of communication are not limited to those described above.

At least some of the functions of the elements of the information processing apparatus 10 shown in FIG. 2 can be realized by the CPU 801 executing programs. At least some of the functions of the elements of the information processing apparatus 10 shown in FIG. 2 may, however, be operated as dedicated hardware. In this case, the dedicated hardware operates under the control of the CPU 801.

The disclosure includes the following embodiments.
[1] An information processing apparatus comprising: a generation unit configured to generate a trajectory sequence of a user device that is moving, the trajectory sequence including at least one IP address of the user device and at least one piece of position information representing a region including a position of the user device; an acquisition unit configured to acquire an IP address of a target user device as a target IP address; and a prediction unit configured to predict position information corresponding to the target IP address by inputting the target IP address to a learning model for machine learning that has learned a correspondence relationship between IP addresses and position information using the trajectory sequence.
[2] The information processing apparatus according to [1], wherein the generation unit generates the at least one piece of position information regarding the user device by encoding coordinate data indicating the position of the user device in a predetermined coordinate system into position information assigned to the region including the position.
[3] The information processing apparatus according to [1] or [2], wherein the position information is a geohash consisting of a predetermined number of digits.
[4] The information processing apparatus according to any one of [1] to [3], wherein the region has a size represented by a geohash consisting of a predetermined number of digits.
[5] The information processing apparatus according to any one of [2] to [4], wherein the coordinate data is data including a latitude and a longitude.
[6] The information processing apparatus according to any one of [2] to [5], wherein the at least one IP address is attached with time information indicating a time when the IP address is used by the user device, and the at least one piece of position information is attached with time information indicating a time when the position information is acquired by the user device, and the generation unit generates the trajectory sequence by arranging the IP address of the user device and the position information regarding the user device in order in accordance with the time information attached to the IP address of the user device and the time information attached to the position information regarding the user device.
[7] The information processing apparatus according to any one of [1] to [6], wherein the generation unit generates the at least one IP address by tokenizing consecutive IP addresses acquired from the user device.
[8] The information processing apparatus according to any one of [1] to [7], further comprising: a training unit configured to train the learning model, wherein the generation unit generates correct answer data including a reference IP address and reference position information that is position information corresponding to the reference IP address, and the training unit trains the learning model by: masking one or more of the at least one IP address and the at least one piece of position information included in the trajectory sequence, and pre-training the learning model to predict a masked portion; and fine-tuning the pre-trained learning model using the correct answer data.
[9] The information processing apparatus according to [8], wherein the training unit regularly fine-tunes the pre-trained learning model using the correct answer data.
[10] The information processing apparatus according to any one of [1] to [9], wherein the acquisition unit acquires position information regarding the target user device as target position information, and the prediction unit predicts an IP address corresponding to the target position information by inputting the target position information to the trained learning model.

What is claimed is:

1. An information processing apparatus comprising:
a generation unit configured to generate a trajectory sequence of a user device that is moving, the trajectory sequence including at least one IP address of the user device and at least one piece of position information representing a region including a position of the user device;
an acquisition unit configured to acquire an IP address of a target user device as a target IP address; and
a prediction unit configured to predict position information corresponding to the target IP address by inputting the target IP address to a learning model for machine learning that has learned a correspondence relationship between IP addresses and position information using the trajectory sequence.

2. The information processing apparatus according to claim 1,
wherein the generation unit generates the at least one piece of position information regarding the user device by encoding coordinate data indicating the position of the user device in a predetermined coordinate system into position information assigned to the region including the position.

3. The information processing apparatus according to claim 2, wherein the position information is a geohash consisting of a predetermined number of digits.

4. The information processing apparatus according to claim 2, wherein the region has a size represented by a geohash consisting of a predetermined number of digits.

5. The information processing apparatus according to claim 2, wherein the coordinate data is data including a latitude and a longitude.

6. The information processing apparatus according to claim 2,
wherein the at least one IP address is attached with time information indicating a time when the IP address is used by the user device, and the at least one piece of position information is attached with time information indicating a time when the position information is acquired by the user device, and
the generation unit generates the trajectory sequence by arranging the IP address of the user device and the position information regarding the user device in order in accordance with the time information attached to the IP address of the user device and the time information attached to the position information regarding the user device.

7. The information processing apparatus according to claim 1,
wherein the generation unit generates the at least one IP address by tokenizing consecutive IP addresses acquired from the user device.

8. The information processing apparatus according to claim 1, further comprising:
a training unit configured to train the learning model,
wherein the generation unit generates correct answer data including a reference IP address and reference position information that is position information corresponding to the reference IP address, and
the training unit trains the learning model by:
masking one or more of the at least one IP address and the at least one piece of position information included in the trajectory sequence, and pre-training the learning model to predict a masked portion; and
fine-tuning the pre-trained learning model using the correct answer data.

9. The information processing apparatus according to claim 8, wherein the training unit regularly fine-tunes the pre-trained learning model using the correct answer data.

10. The information processing apparatus according to claim 1,
wherein the acquisition unit acquires position information regarding the target user device as target position information, and
the prediction unit predicts an IP address corresponding to the target position information by inputting the target position information to the trained learning model.

11. An information processing method to be performed by an information processing apparatus, the method comprising:
generating a trajectory sequence of a user device that is moving, the trajectory sequence including at least one IP address of the user device and at least one piece of position information representing a region including a position of the user device;
acquiring an IP address of a target user device as a target IP address; and
predicting position information corresponding to the target IP address by inputting the target IP address to a learning model for machine learning that has learned a correspondence relationship between IP addresses and position information using the trajectory sequence.

12. A non-transitory computer readable medium storing an information processing program for causing a computer to perform information processing, the program causing the computer to execute processing including:
generation processing for generating a trajectory sequence of a user device that is moving, the trajectory sequence including at least one IP address of the user device and at least one piece of position information representing a region including a position of the user device;
acquisition processing for acquiring an IP address of a target user device as a target IP address; and
prediction processing for predicting position information corresponding to the target IP address by inputting the target IP address to a learning model for machine learning that has learned a correspondence relationship between IP addresses and position information using the trajectory sequence.
